(19) United States
(12) Patent Application Publication
(10) Pub. No.: US 2011/0117439 A1
(43) Pub. Date: May 19, 2011

(54) MICROPOROUS MEMBRANES AND METHODS FOR PRODUCING AND USING SUCH MEMBRANES

(75) Inventors: Kazuhiro Yamada, Tochigi (JP); Teiji Nakamura, Tokyo (JP)

(73) Assignee: TORAY TONEN SPECIALITY GODO KAISHA, Tochigi (JP)

(21) Appl. No.: 13/003,381

(22) PCT Filed: Jun. 24, 2009
(86) PCT No.: PCT/JP2009/062021

§ 371 Date: Jan. 10, 2011

Related U.S. Application Data
(60) Provisional application No. 61/080,134, filed on Jul. 11, 2008.

(30) Foreign Application Priority Data
Nov. 18, 2008 (EP) 08169338.4

(51) Int. Cl. H01M 2/16; H01M 2/18; B29C 55/04; B29C 55/10

(52) U.S. Cl. 429/254; 429/247; 429/249; 264/288.8

(57) ABSTRACT

The invention relates to microporous polymeric membranes suitable for use as battery separator film. The invention also relates to a method for producing such a membrane, batteries containing such membranes as battery separators, methods for making such batteries, and methods for using such batteries.

### FIELD OF THE INVENTION

The invention relates to microporous polymeric membranes suitable for use as battery separator film. The invention also relates to a method for producing such a membrane, batteries containing such membranes as battery separators, methods for making such batteries, and methods for using such batteries.

### BACKGROUND OF THE INVENTION

Microporous membranes can be used as battery separators in, e.g., primary and secondary lithium batteries, lithium polymer batteries, nickel-hydrogen batteries, nickel-cadmium batteries, nickel-zinc batteries, silver-zinc secondary batteries, etc. When microporous membranes are used for battery separators, particularly lithium ion battery separators, the membranes' characteristics significantly affect the properties, productivity and performance of the batteries. While relatively high permeability (generally measured as air permeability) is desirable because it leads to batteries having lower internal resistance, improving this property can lead to a reduction in the membrane's pin puncture strength. Accordingly, it is desirable for the microporous membrane to have an appropriate balance of air permeability and pin puncture strength, particularly in relatively thick membranes of 20.0 μm or more, and particularly 23.0 μm or more, e.g., 23.0 μm to 26.0 μm.

One method for producing microporous membranes, called the “wet process” involves extruding a mixture of polyolefin and a liquid paraffin solvent, stretching the extrudate, and then removing the solvent. Some prior art references disclose methods for improving membrane properties by way of additional or modified processing steps. For example, Japanese Patent Application Laid Open No. JP2001-192487 and JP2001-172420 disclose examples of relatively thick microporous membranes (27 μm) having relatively large pin puncture strength but with diminished air permeability. The membranes are produced in a wet process that involves a thermal treatment following dry orientation. While such membranes exhibit improved pin puncture strength, they can have undesirably high (poor) air permeability Gurley values.

Other references disclose methods for producing membranes having improved properties by using alternative solvents. For example, U.S. Published Patent Application No. 2006/0103055 discloses microporous membranes having improved air permeability and pin puncture strength characteristics produced from a polyolefin-solvent mixture that undergoes a thermally-induced liquid-liquid phase separation at a temperature not lower than the polyolefin's crystallization temperature. Such solvents are expensive and can be difficult to handle.

Further references disclose methods for producing membranes having improved properties by using alternative polyolefins. For example, JP2002-128942, JP2002-128943, and JP2002-284918 disclose processes using polyolefins in particular molecular weight ranges and/or produced using particular catalysts. Generally, the methods disclosed in these references are more successful at increasing the membrane's pin puncture strength than improving air permeability.

While improvements have been made, there is still a need for microporous membranes suitable for use as a battery separator film where the membrane has an increased pin puncture strength and air permeability, and a better balance of these properties.

### SUMMARY OF THE INVENTION

In an embodiment, the invention relates to a method for producing a microporous membrane, comprising:
(a) stretching an extrudate comprising (i) 60.0 wt. % to 80.0 wt. % of a liquid paraffin and (ii) 20.0 wt. % to 40.0 wt. % of a polyolefin mixture, the weight percents being based on the weight of the extrudate; the polyolefin mixture comprising 25.0 wt. % to 35.0 wt. % of a first polyethylene having an Mw≧1.0×10⁶ and 65.0 wt. % to 75.0 wt. % of a second polyethylene having an Mw<1.0×10⁶ and having a terminal unsaturation amount of less than 0.2 per 10,000 carbon atoms in the second polyethylene, the weight percents being based on the weight of the polyolefin mixture;
(b) removing at least a portion of the liquid paraffin from the stretched extrudate to produce a dried extrudate having a first dry length and a first dry width; and
(c) stretching the dried extrudate from the first dry width to a second dry width larger than the first dry width by a magnification factor in the range of from about 1.3 to about 1.4, the stretching being conducted while exposing the dried extrudate to a temperature in the range of about 126.0° C. to 131.0° C. to produce the microporous membrane, wherein the first dry length is constant during the stretching. In an embodiment, the membrane has a normalized pin puncture strength that is ≧20.0 gF per μm (196.0 mN/μm) and a normalized air permeability that is ≦11.0 seconds per 100.0 cm³ per μm.

In another embodiment, the invention relates to a microporous membrane produced by the preceding process.

In another embodiment, the invention relates to a monolayer microporous polymeric membrane having a normalized pin puncture strength greater than or equal to 20.0 gF per μm, a normalized air permeability ≦11.0 seconds/100.0 cm³/μm, the surface of the membrane comprising micro-fibrils having an average diameter in the range of 20.0 nm to 1.0×10² nm and an average distance between micro-fibrils of more than 4.0×10² nm.

In another embodiment, the invention relates to a microporous membrane obtained from an extrudate comprising polyolefin and a paraffinic diluent, the membrane having a normalized pin puncture strength ≧20.0 gF per μm and a normalized air permeability ≦11.0 seconds/100.0 cm³/μm.

In yet another embodiment, the invention relates to a battery comprising an anode, a cathode, an electrolyte, and at least one battery separator located between the anode and the cathode, the battery separating comprising the microporous membrane of any of the preceding embodiments. The battery can be, e.g., a lithium ion primary or secondary battery. The battery can be used as a source or sink of electric charge, e.g., as a power source for a power tool such as a battery-operated saw or drill.

### BRIEF DESCRIPTION OF THE DRAWING

FIG. 1 is a graph showing the relationship between normalized pin puncture strength and normalized air permeability for selected microporous membranes.

### DETAILED DESCRIPTION OF THE INVENTION

In an embodiment, the invention relates to microporous membranes, especially monolayer membranes, having improved strength and air permeability, and an improved balance of these properties. In another embodiment, the invention relates to a method for producing such membranes. In the production method, an initial method step involves combining polymer resins, e. g., polyolefin resins such as polyethylene resins, with a paraffinic diluent, and then extruding the polymer and diluent to make an extrudate. The process conditions in this initial step can be the same as those described in PCT Publications WO 2007/132942 and WO 2008/016174, for example, which are incorporated by reference herein in their entirety.

### [I] Composition and Structure of the Microporous Membrane

In an embodiment, the microporous membrane is produced from an extrudate comprising a first polyethylene having a weight average molecular weight of ≧1.0×10⁶ (referred to as the “first polyethylene”) and a second polyethylene, the second polyethylene having a weight average molecular weight <1.0×10⁶ and having a terminal unsaturation amount of less than 0.2 per 10,000 carbon atoms.

In an embodiment, the microporous membrane is a monolayer membrane, e.g., it is not laminated or coextruded with additional layers, e.g., additional polymeric layers. It is, however, within the scope of the invention for the polymer(s) comprising the monolayer membrane to exhibit a concentration gradient in the thickness direction. This might occur, for example, when the membrane is produced from at least two polyethylenes and the membrane exhibits an increased concentration of one of the constituent polyethylenes near the surface of the membrane.

In another embodiment, the invention is a multilayer membrane, where at least one layer of the multi-layer membrane has a normalized pin puncture strength ≧20.0 gF per μm, a normalized Gurley air permeability≦11.0 seconds per 10.0 cm³/μm, the surface of the membrane comprising micro-fibrils, wherein the micro-fibrils have an average diameter in the range of 20.0 to 100.0 nm and an average distance between micro-fibrils of more than 400.0 nm. Such layered membranes can be produced by conventional methods such as lamination and co-extrusion, as described in WO 2008/016174.

The membrane produced from the extrudate can consist essentially of or even consist of polyethylene, where the term “polyethylene” means homopolymer or copolymer wherein at least 90.0% (by number) of the recurring units are ethylene units.

The first and second polyethylenes and the paraffinic diluent used to produce the extrudate and the microporous membrane will now be described in more detail.

### [II] Materials Used to Produce the Microporous Membrane

The first polyethylene can be, for example, a polyethylene having a weight average molecular weight (“Mw”)≧1.0×10⁶, e.g., in a range of 1.0×10⁶ to 5.0×10⁶, and having and a molecular weight distribution (“MWD”, defined as weight average molecular weight divided by number average molecular weight) in the range of from about 2.0 to about 1.0×10². A non-limiting example of the first polyethylene resin for use herein is ultra-high molecular weight polyethylene (“UHMWPE”) having an Mw of from about 1.1×10⁶ to about 3.0×10⁶, for example from about 2.0×10⁶, and an MWD of from about 2.0 to about 50.0, such as from about 4.0 to 15.0. The first polyethylene can be an ethylene homopolymer, or an ethylene/α-olefin copolymer containing ≦10.0%, of one or more α-olefin comonomers. The α-olefin comonomers, which are not ethylene, can be, for example, propylene, butene-1, pentene-1, hexene-1,4-methylpentene-1, octene-1, vinyl acetate, methyl methacrylate, or styrene or combinations thereof. Such copolymer can be produced using a single-site catalyst, though this is not required.

The second polyethylene has an Mw<1.0×10⁶, such as in the range of from about 2.0×10⁵ to about 9.0×10⁵, an MWD in the range of from about 2.0 to about 1.0×10², and having a terminal unsaturation amount of less than 0.2 per 10,000 carbon atoms. A non-limiting example of the second polyethylene for use herein is a high-density polyethylene (“HDPE”) having an Mw in the range of from about 3.0×10⁵ to about 7.0×10⁵, for example about 5.0×10⁵, and an MWD in the range of from about 2.0 to about 50.0, such as from about 3.0 to 10.0, or 3.5 to 5.0. The second polyethylene can be an ethylene homopolymer, or an ethylene/α-olefin copolymer containing ≦10.0 mol. % of one or more α-olefin comonomers. The α-olefin comonomers, which are not ethylene, can be, e.g., propylene, butene-1, pentene-1, hexene-1, 4-methylpentene-1, octene-1, vinyl acetate, methyl methacrylate, or styrene or combinations thereof. The polymer can be produced, e.g., in a process using a Ziegler-Natta or single-site polymerization catalyst, but this is not required. The amount of terminal unsaturation can be measured in accordance with the procedures described in PCT Publication WO97/23554, for example.

The diluent is a paraffinic material, which can be, e.g., one or more of aliphatic, alicyclic or aromatic hydrocarbons such as nonane, decane, decalin, p-xylene, undecane, dodecene; liquid paraffin; and mineral oil distillates having boiling points comparable to those of the preceding hydrocarbons. In an embodiment, the diluent is a non-volatile liquid solvent for the polymers used to produce the extrudate. The diluent's viscosity is generally in the range of from about 30 cSt to about 500 cSt, or from about 30.0 cSt to about 200.0 cSt, when measured at a temperature of 25° C. Although the choice of viscosity is not particularly critical, when the viscosity at 25° C. is less than about 30 cSt, the mixture of polymer and diluent might foam, resulting in difficulty in blending. On the other hand, when the viscosity is more than about 500 cSt, it can be more difficult to remove the solvent from the extrudate. The membrane is not produced from the diluents used to produce the microporous membranes disclosed in U.S. Published Patent Application No. 2006/0103055. Those microporous membranes are produced from a polyolefin-solvent mixture that undergoes a thermally-induced liquid-liquid phase separation at a temperature not lower than the polyolefin's crystallization temperature. The mixture of polymer and diluent used in the instant invention does not undergo such a phase separation.

In an embodiment, the amount of diluent in the extrudate can be in the range, e.g., of from about 60.0 wt. % to about 80.0 wt. % based on the weight of the extrudate, with the balance being the polymer used to produce the extrudate, e.g., the combined first and second polyethylene. In other embodiments, the extrudate contains an amount of diluent in the range of about 65.0 wt. % to about 75.0 wt. %, or about 70.0 wt. % to 75.0 wt. %. The polymer used to produce the extrudate can be the second polyethylene or the first and second polyethylene. In one embodiment the polymer used to produce the extrudate comprises (a) from about 25.0 wt. % to about 35.0 wt. %, for example from about 29.0 wt. % to about 31.0 wt. %, of the first polyethylene and (b) from about 65.0 wt. % to about 75.0 wt. %, for example from about 69.0 wt. % to about 71.0 wt. % of the second polyethylene, the weight percents being based on the total weight of polymer used to produce the extrudate. In an embodiment, the extrudate is produced from polyethylene and diluent only. Optionally, the polyethylene is combined with ≦1.0 wt. % of antioxidant, based on the weight of the polyethylene.

While the extrudate and the microporous membrane can contain copolymers, inorganic species (such as species containing silicon and/or aluminum atoms), and/or heat-resistant polymers such as those described in PCT Publications WO 2007/132942 and WO 2008/016174, these are not required. In an embodiment, the extrudate and membrane are substantially free of such materials. Substantially free in this context means the amount of such materials in the microporous membrane is less than 1.0 wt. %, based on the total weight of the polymer used to produce the extrudate.

### [III] Method of Producing the Microporous Membrane

In an embodiment, the microporous membrane is a monolayer (single-layer) membrane produced from a monolayer extrudate. Optionally, the membrane contains additional layers and/or coatings.

In an embodiment, the microporous membrane is produced by a process comprising the steps of (1) combining polymer and diluent, (2) extruding the combined polymer and diluent through a die to form an extrudate, (3) optionally exposing the extrudate to a temperature in the range of 15.0° C. to 25.0° C. to form a cooled extrudate, e.g., a gel-like sheet, (4) stretching the cooled extrudate in the transverse and machine directions to a magnification factor in the range of 4.0 to 6.0 while exposing the extrudate to a temperature in the range of about 110.0° C. to 120.0° C., (5) removing at least a portion of the diluent from the stretched extrudate to form a dried extrudate having a first dry length and a first dry width, and optionally removing at least a portion of any volatile species, and (6) stretching the dried extrudate in the transverse direction from the first dry width to a second dry width that is larger than the first dry width by a magnification factor in the range of from about 1.3 to about 1.4, without changing the first dry length to produce the membrane, the stretching being conducted while exposing the dried extrudate to a temperature in the range of 126.0° C. to 131.0° C.

Additional optional steps that are generally useful in the production of microporous membranes can be used. For example, an optional hot solvent treatment step, an optional heat setting step, an optional cross-linking step with ionizing radiation, and an optional hydrophilic treatment step, etc., all as described in PCT Publications WO 2007/132942 and WO2008/016174 can be conducted if desired. Neither the number nor order of these optional steps is critical.

### (1) Combining Polymer and Diluent

The polymers as described above can be combined, e.g., by dry mixing or melt blending, and then this mixture can be combined with an appropriate diluent (or mixture of diluents) to produce a mixture of polymer and diluent. When the diluent is a solvent for one or more of the polymers, the mixture can be called a polymeric solution. Alternatively, the polymer(s) and diluent can be combined in a single step. The mixture can contain additives such as one or more antioxidant. In an embodiment, the amount of such additives does not exceed 1.0 wt. % based on the weight of the polymeric solution. The choice of mixing conditions, extrusion conditions, etc. can be the same as those disclosed in PCT Publication No. WO 2008/016174, for example.

### (2) Extruding

In an embodiment, the combined polymer and diluent are conducted from an extruder to a die.

The extrudate or cooled extrudate (as hereinafter described) should have an appropriate thickness to produce, after the stretching steps, a final membrane having the desired thickness (generally ≧20.0 μm). For example, the extrudate can have a thickness in the range of about 1.2 mm to 1.8 mm, or 1.3 mm to 1.7 mm. Process conditions for accomplishing this extrusion can be the same as those disclosed in PCT Publications WO 2007/132942 and WO 2008/016174, for example. The machine direction (“MD”) is defined as the direction in which the extrudate is produced from the die. The transverse direction (“TD”) is defined as the direction perpendicular to both MD and the thickness direction of the extrudate. The extrudate can be produced continuously from a die, or it can be produced from the die in portions (as is the case in batch processing) for example. The definitions of TD and MD are the same in both batch and continuous processing.

### (3) Formation of a Cooled Extrudate

The extrudate can be exposed to a temperature in the range of 15° C. to 25° C. to form a cooled extrudate. Cooling rate is not particularly critical. For example, the extrudate can be cooled at a cooling rate of at least about 30° C./minute until the temperature of the extrudate (the cooled temperature) is approximately equal to the extrudate's gelation temperature (or lower). Process conditions for cooling can be the same as those disclosed in PCT Publications No. WO 2008/016174 and WO 2007/132942, for example. In an embodiment, the cooled extrudate has a thickness in the range of 1.2 mm to 1.8 mm, or 1.3 mm to 1.7 mm.

### (4) Stretching the Extrudate

The extrudate or cooled extrudate is then stretched in at least one direction (e.g., at least one planar direction, such as MD or TD) to produce a stretched extrudate. For example, the extrudate can be stretched simultaneously in MD and TD to a magnification factor in the range of 4.0 to 6.0 while exposing the extrudate to a temperature in the range of about 110.0° C. to 120.0° C., e.g., 114.0° C. to 116.0° C. In an embodiment, the stretching temperature is about 115.0° C. Suitable stretching methods are described in PCT Publications No. WO 2008/016174 and WO 2007/13294, for example. While not required, the MD and TD magnifications can be the same. In an embodiment, the stretching magnification is equal to 5.0 in MD and TD and the stretching temperature is 115.0° C.

In an embodiment, the stretched extrudate undergoes an optional thermal treatment before diluent removal. In the thermal treatment, the stretched extrudate is exposed to a temperature≧the temperature to which the extrudate is exposed during stretching. The planar dimensions of the stretched extrudate (length in MD and width in TD) can be held constant while the stretched extrudate is exposed to the higher temperature. Since the extrudate contains polymer and diluent, its length and width are referred to as the “wet” length and “wet” width. In an embodiment, the stretched extrudate is exposed to a temperature in the range of 120.0° C. to 125.0° C. for a time in the range of 1.0 second to 1.0×10² seconds while the wet length and wet width are held constant, e.g., by using tenter clips to hold the stretched extrudate along its perimeter. In other words, during the thermal treatment, there is no magnification or demagnification (i.e., no dimensional change) of the stretched extrudate in MD or TD.

In this step and in other steps such as dry orientation and heat setting where the sample (e.g., the extrudate, dried extrudate, membrane, etc.) is exposed to an elevated temperature, this exposure can be accomplished by heating air and then conveying the heated air into proximity with the sample. The temperature of the heated air, which is generally controlled at a set point equal to the desired temperature, is then conducted toward the sample through a plenum for example. Other methods for exposing the sample to an elevated temperature, including conventional methods such as exposing the sample to a heated surface, infra-red heating in an oven, etc. can be used with or instead of heated air.

### (5) Removal of the Diluent

In an embodiment, at least a portion of the diluent is removed (or displaced) from the stretched extrudate, e.g., to form a dried extrudate. A displacing (or “washing”) solvent can be used to remove (wash away, or displace) the diluent, as described in PCT Publications No. WO 2008/016174 and WO 2007/132942, for example. The term “dried extrudate” refers to an extrudate from which at least a portion of the diluent has been removed. It is not necessary to remove all diluent from the stretched extrudate, although it can be desirable to do so since removing diluent increases the porosity of the final membrane.

In an embodiment, at least a portion of any remaining volatile species, such as washing solvent, can be removed from the dried extrudate at any time after diluent removal. Any method capable of removing the washing solvent can be used, including conventional methods such as heat-drying, wind-drying (moving air), etc. Process conditions for removing volatile species such as washing solvent can be the same as those disclosed in PCT Publications No. WO 2008/016174 and WO 2007/132942, for example.

### (6) Stretching the Membrane (Dry Orientation)

Following diluent removal, the extrudate is stretched to produce the microporous membrane. At the start of this step, the diluent-removed extrudate has an initial size in MD (a first dry length) and an initial size in TD (a first dry width). The extrudate is then stretched in TD from the first dry width to a second dry width that is larger than the first dry width by a magnification factor≧1.3, e.g., in the range of from about 1.3 to about 1.4 (e.g., 1.33 to 1.37), without changing the first dry length. The stretching is conducted while exposing the membrane to a temperature in the range of 126.0° C. to 131.0° C., e.g., 126.6° C. to 127.9° C. In an embodiment, the magnification factor is 1.35 and the temperature is 127.9° C.

As used herein, the term “first dry width” refers to the size of the diluent-removed extrudate in TD prior to the start of dry orientation. The term “first dry length” refers to the size of the diluent-removed extrudate in MD prior to the start of dry orientation.

The stretching rate is preferably 1.0%/second or more in TD. The stretching rate is preferably 2.0%/second or more, more preferably 3.0%/second or more, e.g., in the range of 2.0%/second to 10.0%/second. Though not particularly critical, the upper limit of the stretching rate is generally about 50.0%/second.

The dry (and wet) magnification factor operates multiplicatively on film size. For example, a film having an initial width (TD) of 2.0 cm that is stretched in TD to a magnification factor of 4.0 (“4-fold”) will have a final width of 8.0 cm.

### (7) (Optional) Controlled Reduction of the Membrane's Width

If desired, the membrane produced in step (6) can be subjected to a controlled reduction in width from the second dry width to a third dry width, the third dry width being in the range of from a factor of 1.0 times the first dry width to about 1.39 times the first width. In a preferred embodiment, the third width is in the range of from 1.2 times larger than the first width to 1.3 times larger than the first width. The dry width can be reduced while the membrane is exposed to a temperature that is higher (warmer) than the temperature to which the dried extrudate was exposed in step (6), although this is not required. In an embodiment, the membrane is exposed to a temperature in the range of, e.g., in the range of 126.0° C. to 131.0° C., or 126.6° C. to 127.9° C.

### (8) Optional Heat Set

The membrane of steps (6) and/or (7) can be optionally thermally treated (heat-set) to stabilize crystals and make uniform lamellas in the membrane. The heat-setting step can be conducted, e.g., by conventional methods such as tenter method or a roll method. The heat-setting is conducted by maintaining the first dry length and the second or third dry width constant (e.g., by holding the membrane's perimeter with tenter clips), while exposing the membrane to a temperature in the range of 127.0° C. to 131.0° C., e.g., 126.9° C. to 127.9° C. for a time in the range of 1.0 to 1.0×10² seconds. In an embodiment, the heat setting temperature is 127.9° C., and is conducted under conventional heat-set “thermal fixation” conditions, i.e., with no change in the membrane's planar dimensions. It is believed that exposing the membrane of step (7) to a temperature that is higher than the temperature to which the membrane is exposed during the stretching of step (6) generally produces a membrane having reduced TD heat shrinkage.

Optionally, an annealing treatment can be conducted before, during, or after the heat-setting. The annealing is a heat treatment with no load applied to the microporous membrane, and may be conducted by using, e.g., a heating chamber with a belt conveyor or an air-floating-type heating chamber. The annealing may also be conducted continuously after the heat-setting with the tenter slackened. The annealing temperature is preferably in a range from about 126.9° C. to 128.9° C. Annealing is believed to provide the microporous membrane with improved heat shrinkage and strength.

Optional heated roller, hot solvent, cross linking, hydrophilizing, and coating treatments can be conducted if desired, e.g., as described in PCT Publication No. WO 2008/016174.

### [IV] Structure, Properties, and Composition of Microporous Membrane

### (1) Structure

The thickness of the final membrane is generally ≧20.0 μm, such as ≧23.0 μm. For example, the membrane can have a thickness in the range of from about 23.0 μm to about 30.0 μm, e.g., from about 24.0 μm to about 26.0 μm. In an embodiment, the thickness of the membrane is in the range of 20.0 μm to 21.0 μm, or 21.0 μm to 22.0 μm, or 22.0 μm to 23.0 μm, or 23.0 μm to 24.0 μm, or 24.0 μm to 25.0 μm, or 25.0 μm to 26.0 μm to 27.0 μm. The thickness of the microporous membrane can be measured, e.g., by a contact thickness meter at 1.0 cm longitudinal intervals over the width of 10.0 cm, and then averaged to yield the membrane thickness. Thickness meters such as the Litematic available from Mitsutoyo Corporation are suitable. Non-contact thickness measurement methods are also suitable, e.g. optical thickness measurement methods.

The planar surfaces of the final membrane comprise a network of micro-fibrils. The micro-fibrils generally comprise the polymer(s) used for producing the membrane. The average diameter of the micro-fibrils is in the range of 20.0 nm to 1.0×10² nm, and the average distance between the micro-fibrils (i.e., adjacent micro-fibrils) is more than 4.0×10² nm. In an embodiment, the average diameter of the micro-fibrils is in the range of 40.0 nm to 70.0 nm, and the average distance between micro-fibrils is in the range of 450 nm to 650 nm. The micro-fibril diameter and the average distance between micro-fibrils can be measured using Atomic Force Microscopy (“AFM”), scanning electron microscopy (“SEM”) or any other method having sufficient sensitivity and resolution to image polymeric micro-fibrils in the appropriate size range.

When AFM is used, a model SPA500 scanning probe microscope available from Seiko Instruments, Inc. is suitable. Average micro-fibril diameter and the average distance between micro-fibrils can be obtained directly from the AFM images, e.g., by averaging the measured size and spacing of the micro-fibrils appearing in the image (generally at least 5 measurements are averaged). In the examples that follow, a 4.0 μm×4.0 μm area of each sample (sample size is 5.0 mm×5.0 mm) is imaged directly using AFM. Average micro-fibril diameter is obtained from the micrograph by measuring the diameter of five micro-fibrils and averaging (arithmetic mean) the measurements. Average distance between micro-fibrils is obtained from the micrograph by measuring the distance between adjacent (nearest neighbor) micro-fibrils at five places in the area imaged in the micrograph and averaging (arithmetic mean) the measurements. The membrane is mounted on the AFM sample stage using conductive double-sided tape. The AFM scanning frequency is in the range of 0.10 to 0.25 Hz, e.g., 0.16 Hz; with an attenuation rate (amplitude dumping rate) in the range of −0.1 to −0.6, e.g., −0.140.

When SEM is used, the measurement and analysis methods described in Published U.S. Patent Application No. 2006/0103055 are suitable. Paragraphs 102 to 117 of US2006/0103055 are incorporated by reference herein.

### (2) Properties

In preferred embodiments, the microporous membrane of the present invention also has at least one of the following properties.

(a) A Normalized Air Permeability ≦12.0 sec/100.0 cm³/μm

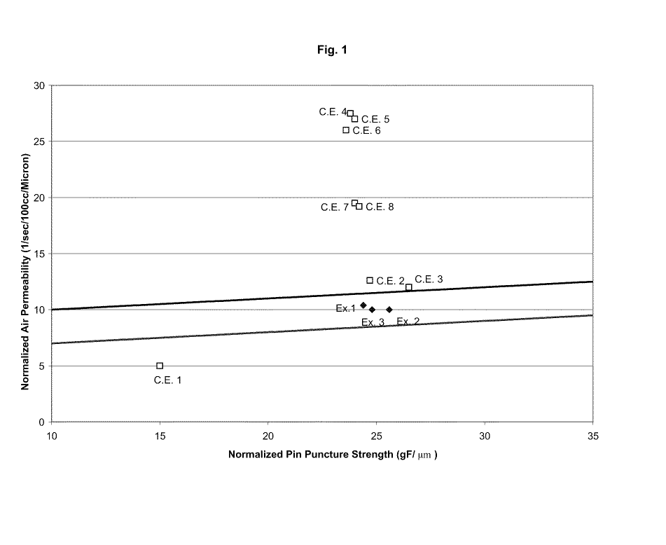

Air permeability is measured according to JIS P8117, and the results are normalized to a value at a thickness of 1.0 μm using the equation A=(X)/T₁, where X is the measured air permeability of a membrane having an actual thickness T₁ (in μm) and A is the normalized air permeability at a thickness of 1.0 μm. In an embodiment, the normalized air permeability is 11.0 sec/100.0 cm³/μm or less, e.g., in the range of 10.5 sec/100.0 cm³/μm to 7.0 sec/100.0 cm³/μm. In another embodiment, the normalized air permeability is in the range of about 5.0 sec/100.0 cm³/μm to 136.0 sec/100.0 cm³/μm, or 8.0 sec/100.0 cm³/μm to about 15.0 sec/100.0 cm³/μm, or about 10.0 sec/100.0 cm³/μm to about 11.0 sec/100.0 cm³/μm. In another embodiment, the membrane's normalized air permeability satisfies the relationship A≦(0.1*P)+9, where P is the membrane's normalized pin puncture strength as hereinafter defined (measured in gF). In yet another embodiment, the normalized air permeability satisfies the relationship (0.1*P)+6≦A≦(0.1*P)+9. The lines A=(0.1*P)+6 and A=(0.1*P)+9 are shown as solid lines on FIG. 1.

### (b) Porosity ≧45.0%

The membrane's porosity is measured conventionally by comparing the membrane's actual weight to the weight of an equivalent non-porous membrane of 100.0% polyethylene (equivalent in the sense of having the same length, width, and thickness). Porosity is then determined using the formula: Porosity %=100.0×(w2−w1)/w2, wherein “w1” is the actual weight of the microporous membrane and “w2” is the weight of an equivalent non-porous membrane of 100% polyethylene having the same size and thickness. In an embodiment, the membrane has a porosity in the range of from about 41.0% to about 60.0%, such as about 45.0% to about 50.0%.

(c) Normalized Pin Puncture Strength ≧20.0 gF/μm (≧196 mN)

Pin puncture strength is defined as the maximum load measured (in grams Force or “gF”) when a microporous membrane having a thickness of T₁ is pricked with a needle of 1.0 mm in diameter with a spherical end surface (radius R of curvature: 0.5 mm) at a speed of 2 mm/second. The pin puncture strength is normalized to a value at a membrane thickness of 1.0 μm using the equation L₂=(L₁)/T₁, where L₁ is the measured pin puncture strength, L₂ is the normalized pin puncture strength, and T₁ is the average thickness of the membrane in μm.

In an embodiment, the normalized pin puncture strength is in the range of 22.0 gF to 35.0 gF/μm, or from 24.0 gF/μm to 28.0 gF/μm.

### (d) MD Tensile Strength ≧1.0×10³ Kg/cm² and TD Tensile Strength≧1.2×10³ Kg/cm²

Tensile strength is measured in MD and TD according to ASTM D-882A. In an embodiment, the membrane's MD tensile strength is in the range of 1.0×10³ Kg/cm² to 2.0×10³ Kg/cm², and TD tensile strength is in the range of 1.2×10³ Kg/cm² to 2.3×10³ Kg/cm².

### (e) MD and TD Tensile Elongation of 50.0% or More

Tensile elongation is measured according to ASTM D-882A. In an embodiment, the membrane's MD and TD tensile elongation are each in the range of 50.0% to 350%. In another embodiment, the membrane's MD tensile elongation is in the range of, e.g., 150% to 200.0% and TD tensile elongation is in the range of, e.g., 140% to 230%.

### (f) Shutdown Temperature ≦140.0° C.

The shutdown temperature of the microporous membrane is measured by a thermomechanical analyzer (TMA/SS6000 available from Seiko Instruments, Inc.) as follows: A rectangular sample of 3.0 mm×50.0 mm is cut out of the microporous membrane such that the long axis of the sample is aligned with the microporous membrane's TD and the short axis is aligned with MD. The sample is set in the thermomechanical analyzer at a chuck distance of 10.0 mm, i.e., the distance from the upper chuck to the lower chuck is 10.0 mm. The lower chuck is fixed and a load of 19.6 mN applied to the sample at the upper chuck. The chucks and sample are enclosed in a tube which can be heated. Starting at 30.0° C., the temperature inside the tube is elevated at a rate of 5.0° C./minute, and sample length change under the 19.6 mN load is measured at intervals of 0.5 second and recorded as temperature is increased. The temperature is increased to 200.0° C. “Shutdown temperature” is defined as the temperature of the inflection point observed at approximately the melting point of the polymer having the lowest melting point among the polymers used to produce the membrane. In an embodiment, the shutdown temperature is 140.0° C. or less, e.g., in the range of 128.0° C. to 136.0° C., such as 130.0° C. to 135.0° C.

### (g) Meltdown Temperature ≧144.0° C.

Meltdown temperature is measured by the following procedure: A rectangular sample of 3.0 mm×50.0 mm is cut out of the microporous membrane such that the long axis of the sample is aligned with the microporous membrane's TD and the short axis is aligned with MD. The sample is set in the thermomechanical analyzer (TMA/SS6000 available from Seiko Instruments, Inc.) at a chuck distance of 10 mm, i.e., the distance from the upper chuck to the lower chuck is 10 mm. The lower chuck is fixed and a load of 19.6 mN applied to the sample at the upper chuck. The chucks and sample are enclosed in a tube which can be heated. Starting at 30° C., the temperature inside the tube is elevated at a rate of 5.0° C./minute, and sample length change under the 19.6 mN load is measured at intervals of 0.5 second and recorded as temperature is increased. The temperature is increased to 200.0° C. The meltdown temperature of the sample is defined as the temperature at which the sample breaks, generally at a temperature in the range of about 145.0° C. to about 200.0° C.

In an embodiment, the meltdown temperature is in the range of from 143.0° C. to 155.0° C., such as from 144.0° C. to 150.0° C.

### (h) TD Heat Shrinkage Ratio at 105.0° C.≦10.0% and MD Heat Shrinkage Ratio at 105.0° C.≦8.5%

The shrinkage ratio of the microporous membrane orthogonal planar directions (e.g., MD or TD) at 105.0° C. is measured as follows:
(i) Measure the size of a test piece of microporous membrane at ambient temperature in both MD and TD, (ii) equilibrate the test piece of the microporous membrane at a temperature of 105.0° C. for 8.0 hours with no applied load, and then (iii) measure the size of the membrane in both MD and TD. The heat (or “thermal”) shrinkage ratio in either MD and TD can be obtained by dividing the result of measurement (i) by the result of measurement (ii) and expressing the resulting quotient as a percent.

In an embodiment, the microporous membrane has a TD heat shrinkage ratio at 105.0° C. in the range of 3.0% to 10.0%, e.g., 4.0% to 8.0%; and an MD heat shrinkage ratio at 105.0° C. in the range of 1.5% to 8.0%, e.g., 2.0% to 6.0%.

### (m) Maximum TD Shrinkage in Molten State ≦46.0% and a Maximum MD Shrinkage in Molten State ≦41.0%

Maximum shrinkage in the molten state is measured by the following procedure: Using the TMA procedure described for the measurement of meltdown temperature, the sample length measured in the temperature range of from 135.0° C. to 145.0° C. are recorded. The membrane shrinks, and the distance between the chucks decreases as the membrane shrinks The maximum shrinkage in the molten state is defined as the sample length between the chucks measured at 23.0° C. (L1 equal to 10 mm) minus the minimum length measured generally in the range of about 135.0° C. to about 145.0° C. (equal to L2) divided by L1, i.e., [L1−L2/L1*100%. When TD maximum shrinkage is measured, the rectangular sample of 3.0 mm×50.0 mm used is cut out of the microporous membrane such that the long axis of the sample is aligned with the microporous membrane's TD and the short axis is aligned with MD. When MD maximum shrinkage is measured, the rectangular sample of 3.0 mm×50.0 mm used is cut out of the microporous membrane such that the long axis of the sample is aligned with the microporous membrane's MD and the short axis is aligned with TD.

In an embodiment, the membrane's maximum TD shrinkage in the molten state is observed to occur (TMA method above) at about 140.0° C. At this temperature, the maximum TD shrinkage in the molten state is in the range of 43.0% to 46.0%; and the maximum MD shrinkage in the molten state is in the range of 37.0% to 41.0%.

### (2) Microporous Membrane Composition

The microporous membrane generally comprises the polymers used to produce the extrudate, in generally the same relative amounts. Washing solvent and/or process solvent (diluent) can also be present, generally in amounts≦approximately 1.0 wt. % based on the weight of the microporous membrane. A small amount of polymer molecular weight degradation might occur during processing, but this is acceptable. In an embodiment where the polymer is polyolefin and the membrane is produced in a wet process, molecular weight degradation during processing, if any, causes the MWD of the polymer in the membrane to differ from the MWD of the polymer used to produce the extrudate by no more than about 5.0%, or no more than about 1.0%, or no more than about 0.1%.

In an embodiment, the microporous membrane comprises the first and second polyethylene, for example from about 25.0 wt. % to about 35.0 wt. % of the first polyethylene and from about 65.0 wt. % to about 75.0 wt. % of the second polyethylene, based on the weight of the membrane. In an embodiment the membrane contains about 30.0 wt. % of the first polyethylene and about 70.0 wt. % of the second polyethylene.

### [V] Battery Separator

In an embodiment, the microporous membrane of any of the preceding embodiments is useful for separating electrodes in energy storage and conversion devices such as lithium ion batteries. The battery separator can comprise the microporous membrane, and optionally can further comprise additional layers of, e.g., microporous membranes, non-woven porous webs, etc.

### [VI] Battery

The microporous membranes of the invention are useful as battery separators in e.g., lithium ion primary and secondary batteries. Such batteries are described in PCT publication WO 2008/016174.

The battery is useful as a source or sink of power from one or more electrical or electronic components, Such components include passive components such as resistors, capacitors, inductors, including, e.g., transformers; electromotive devices such as electric motors and electric generators, and electronic devices such as diodes, transistors, and integrated circuits. The components can be connected to the battery in series and/or parallel electrical circuits to form a battery system. The circuits can be connected to the battery directly or indirectly. For example, electricity flowing from the battery can be converted electrochemically (e.g., by a second battery or fuel cell) and/or electromechanically (e.g., by an electric motor operating an electric generator) before the electricity is dissipated or stored in a one or more of the components. The battery system can be used as a power source for powering relatively high power devices such as electric motors in power tools.

Aspects of the invention will be explained in more detail with respect to embodiments exemplified below. These examples are not meant to foreclose other embodiments within the broader scope of the invention.

### EXAMPLE 1

A polyolefin composition is prepared by combining (a) 70.0 wt. % of polyethylene resin having an Mw of 5.6×10⁵, an MWD of 4.1, and having a terminal unsaturation amount of 0.1 per 10,000 carbon atoms (the “second polyethylene”) with (b) 30.0 wt. % of polyethylene resin having an Mw of 2.0×10⁶ and an MWD of 5.1 (the “first polyethylene”). The combined polyethylene resin in the composition has a melting point of 135° C., and a crystal dispersion temperature of 100° C.

Mw and MWD of the polyethylenes are determined using a High Temperature Size Exclusion Chromatograph, or “SEC”, (GPC PL 220, Polymer Laboratories), equipped with a differential refractive index detector (DRI). Three PLgel Mixed-B columns (available from Polymer Laboratories) are used. The nominal flow rate is 0.5 cm³/min, and the nominal injection volume is 300 μL. Transfer lines, columns, and the DRI detector are contained in an oven maintained at 145° C. The measurement is made in accordance with the procedure disclosed in “Macromolecules, Vol. 34, No. 19, pp. 6812-6820 (2001)”.

The GPC solvent used is filtered Aldrich reagent grade 1,2,4-Trichlorobenzene (TCB) containing approximately 1000 ppm of butylated hydroxy toluene (BHT). The TCB is degassed with an online degasser prior to introduction into the SEC. Polymer solutions is prepared by placing dry polymer in a glass container, adding the desired amount of above TCB solvent, then heating the mixture at 160° C. with continuous agitation for about 2 hours. The concentration of UHMWPE solution is 0.25 to 0.75 mg/ml. Sample solution will be filtered off-line before injecting to GPC with 2 μm filter using a model SP260 Sample Prep Station (available from Polymer Laboratories).

The separation efficiency of the column set is calibrated with a calibration curve generated using a seventeen individual polystyrene standards ranging in Mp from about 580 to about 10,000,000, which is used to generate the calibration curve. The polystyrene standards are obtained from Polymer Laboratories (Amherst, Mass.). A calibration curve (log Mp vs. retention volume) is generated by recording the retention volume at the peak in the DRI signal for each PS standard, and fitting this data set to a 2nd-order polynomial. Samples are analyzed using IGOR Pro, available from Wave Metrics, Inc.

28.5 wt. % of the polyolefin composition is combined in a strong-blending, double-screw extruder with 71.5 wt. % of liquid paraffin (50 cSt at 40° C.). Mixing is conducted at 210° C. to produce a polyethylene solution. The polyethylene solution is extruded from a T-die connected to the double-screw extruder. The extrudate is cooled by contacting the extrudate with cooling rolls having a temperature controlled at 40.0° C., to form a cooled extrudate having a thickness of 1.4 mm. Using a tenter-stretching machine, the extrudate (in the form of a gel-like sheet) is simultaneously biaxially stretched at 115.0° C. to a magnification factor of 5 fold in both MD and TD. The stretched extrudate is then exposed to a temperature of 120.0° C. for 60 seconds while holding the length and width of the sheet constant at a size of 20 cm MD×20 cm TD. While keeping the size of the sheet fixed, the sheet is then immersed in a bath of methylene chloride controlled at 25° C. (to remove the liquid paraffin to an amount of 1.0 wt. % or less of the weight of liquid paraffin present in the polyolefin solution) for 3 minutes, and dried by an air flow at room temperature. At the start of dry orientation, the dried extrudate has an initial size of 1.0×10² mm in TD (the first dry width) and an initial size of 1.0×10² mm in MD (the first dry length). The dried extrudate is stretched by a batch-stretching machine to a magnification factor of 1.35 fold in TD at a temperature of 128.0° C., while maintaining the first dry length constant. The membrane is then heat-set at 128.0° C. for 10 minutes. The properties of the membrane are shown in Table 1. FIG. 1 graphically shows the normalized air permeability and normalized pin puncture strength of the membrane. FIG. 1 also shows reference lines satisfying the equations A=(0.1*P)+6 and A=(0.1*P)+9. The surface morphology of the membrane is analyzed using AFM. At the membrane's surface, the average micro-fibril diameter is 50 nm, and the average distance between micro-fibrils is 510 nm.

### EXAMPLE 2

A polyolefin composition comprising (a) 70.0 wt. % of the second polyethylene resin of Example 1 and 30.0 wt. % of the first polyethylene resin of Example 1 is prepared by dry-blending. The percentages are based on the weight of the polyolefin composition. The polyethylene resin in the polyolefin composition has the same melting point and crystal dispersion temperature as in Example 1.

30.0 wt. % of the resultant polyolefin composition is charged into a strong-blending double-screw extruder with 70 wt. % of liquid paraffin (50 cst at 40° C.), based on the combined weight of the polyolefin composition and the liquid paraffin. Melt-blending is conducted at 210° C. to prepare a polyethylene solution. This polyethylene solution is extruded from a T-die mounted to the double-screw extruder. The extrudate is cooled while passing through cooling rolls controlled at 40.0° C., to form a cooled extrudate, i.e. gel-like sheet having a thickness of 1.4 mm.

Using a tenter-stretching machine, the cooled extrudate is simultaneously biaxially stretched at 115.0° C. to a magnification factor of 5 fold in both MD and TD, and then exposed to a temperature of 121.5° C. for 12 seconds with the tenter clips holding the perimeter of the sheet at a fixed length and width. The stretched extrudate is then immersed in a bath of methylene chloride controlled at 25° C. to remove the liquid paraffin to an amount of 1.0 wt. % or less of the weight of liquid paraffin present in the polyolefin solution, and then dried by flowing air at room temperature. The dried extrudate is stretched (dry orientation) by a tenter stretching machine to a magnification factor of 1.35 fold in TD while exposed to a temperature of 127.9° C. while holding the dry length constant. Following stretching, the dried membrane is heat-set by a tenter-type machine while exposed to a temperature of 127.9° C. for 26 seconds to produce a microporous membrane while holding the dry length and dry width constant. The properties of the membrane are shown in Table 1, and the relationship between normalized air permeability and normalized pin puncture strength is shown in FIG. 1. The surface morphology of the membrane is measured using AFM. At the membrane's surface, the average micro-fibril diameter is 53 nm and the average distance between micro-fibrils is 540 nm.

### EXAMPLE 3

Example 2 is repeated except that the thickness of the cooled extrudate is 1.2 mm and the dry orientation is conducted with the membrane exposed to a temperature of 127.7° C. The properties of the membrane are shown in FIG. 1 and Table 1. The average micro-fibril diameter is 48 nm, and the average distance between micro-fibrils is 480 nm at the surface of the membrane.

### COMPARATIVE EXAMPLE 1

Example 2 is repeated except that the amounts of first and second polyethylenes in the polyolefin composition are 18.0 wt. % and 82.0 wt. % respectively; the amount of polyolefin composition in the polyolefin solution is 25.0 wt. %; the thickness of the cooled extrudate is 1.5 mm; the extrudate is exposed to a temperature of 118.0° C. during biaxial stretching; the biaxially-stretched extrudate is exposed to a temperature of 95.0° C. before liquid paraffin removal; the dry orientation TD magnification factor is 1.40; and dry orientation and heat set are conducted while exposing the membrane to a temperature of 126.8° C.

### COMPARATIVE EXAMPLE 2

Example 2 is repeated except that the amounts of first and second polyethylenes in the polyolefin composition are 2.0 wt. % and 98.0 wt. % respectively; the amount of polyolefin composition in the polyolefin solution is 40.0 wt. %; the thickness of the cooled extrudate is 1.0 mm; the extrudate is exposed to a temperature of 119.3° C. during biaxial stretching; the biaxially-stretched extrudate is exposed to a temperature of 95.0° C. before liquid paraffin removal; the dry orientation TD magnification factor is 1.40; and dry orientation and heat set are conducted while exposing the membrane to a temperature of 130.0° C.

### COMPARATIVE EXAMPLE 3

Example 2 is repeated except that the amount of polyolefin composition in the polyolefin solution is 28.5 wt. %; the thickness of the cooled extrudate is 1.2 mm; the extrudate is exposed to a temperature of 114.0° C. during biaxial stretching; the biaxially-stretched extrudate is exposed to a temperature of 122.0° C. before liquid paraffin removal; the dry orientation TD magnification factor is 1.20; and dry orientation and heat set are conducted while exposing the membrane to a temperature of 128.0° C.

### COMPARATIVE EXAMPLE 4

Example 2 is repeated except that the second polyethylene has an Mw of 750,000, an MWD of 11.8, and a terminal unsaturation amount of 0.6 per 10,000 carbon atoms; the amounts of first and second polyethylenes in the polyolefin composition are 18.0 wt. % and 82.0 wt. % respectively; the amount of polyolefin composition in the polyolefin solution is 30.0 wt. %; the thickness of the cooled extrudate is 0.8 mm; the extrudate is exposed to a temperature of 113.8° C. during biaxial stretching; the biaxially-stretched extrudate is exposed to a temperature of 95.0° C. before liquid paraffin removal; no dry orientation is used; and heat setting is conducted while exposing the membrane to a temperature of 124.3° C.

### COMPARATIVE EXAMPLE 5

Example 2 is repeated except that the second polyethylene has an Mw of 750,000, an MWD of 11.8, and a terminal unsaturation amount of 0.6 per 10,000 carbon atoms; the amounts of first and second polyethylenes in the polyolefin composition are 18.0 wt. % and 82.0 wt. % respectively; the amount of polyolefin composition in the polyolefin solution is 30.0 wt. %; the thickness of the cooled extrudate is 1.0 mm; the extrudate is exposed to a temperature of 114.4° C. during biaxial stretching; the biaxially-stretched extrudate is exposed to a temperature of 95.0° C. before liquid paraffin removal; no dry orientation is used; and heat set is conducted while exposing the membrane to a temperature of 124.7° C.

### COMPARATIVE EXAMPLE 6

Example 2 is repeated except that the second polyethylene has an Mw of 750,000, an MWD of 11.8, and a terminal unsaturation amount of 0.6 per 10,000 carbon atoms; the amounts of first and second polyethylenes in the polyolefin composition are 18.0 wt. % and 82.0 wt. % respectively; the amount of polyolefin composition in the polyolefin solution is 30.0 wt. %; the thickness of the cooled extrudate is 1.2 mm; the extrudate is exposed to a temperature of 114.2° C. during biaxial stretching; the biaxially-stretched extrudate is exposed to a temperature of 95.0° C. before liquid paraffin removal; no dry orientation is used; and heat set is conducted while exposing the membrane to a temperature of 124.3° C.

### COMPARATIVE EXAMPLE 7

Example 2 is repeated except that the amount of polyolefin composition in the polyolefin solution is 25.0 wt. %; the thickness of the cooled extrudate is 1.1 mm; the extrudate is exposed to a temperature of 115.7° C. during biaxial stretching; the biaxially-stretched extrudate is exposed to a temperature of 95.0° C. before liquid paraffin removal; there is no dry orientation; and heat set is conducted while exposing the membrane to a temperature of 126.3° C. Following heat set, the membrane undergoes a controlled reduction in width to a magnification factor of 0.95.

### COMPARATIVE EXAMPLE 8

Example 2 is repeated except the amount of polyolefin composition in the polyolefin solution is 28.5 wt. %; the thickness of the cooled extrudate is 0.7 mm; the extrudate is exposed to a temperature of 116.5° C. during biaxial stretching; the biaxially-stretched extrudate is exposed to a temperature of 95.0° C. before liquid paraffin removal; there is no dry orientation; and heat set is conducted while exposing the membrane to a temperature of 126.5° C. Following heat set, the membrane undergoes a controlled reduction in width to a magnification factor of 0.97.

### Properties

The properties of the microporous membranes obtained in the Examples and Comparative Examples are measured by the methods described above. The results are shown in Table 1.

TABLE 1

| | | | | Comp | Comp | Comp | Comp | Comp | Comp | Comp | Comp |
|---|---|---|---|---|---|---|---|---|---|---|---|
| PROPERTIES | Ex 1 | Ex 2 | Ex 3 | Ex 1 | Ex 2 | Ex 3 | Ex 4 | Ex 5 | Ex 6 | Ex 7 | Ex 8 |
| Thickness μm | 25 | 25 | 25 | 20 | 19 | 20 | 16 | 20 | 25 | 20 | 12 |
| Normalized | 10.4 | 10.0 | 10..0 | 5.0 | 12.6 | 12.0 | 27.5 | 27.0 | 26.0 | 19.5 | 19.2 |
| Air Perm. | | | | | | | | | | | |
| (sec/100 cm³/μm) | | | | | | | | | | | |
| Porosity % | 47 | 47 | 50 | 52 | 39 | 45 | 35 | 36 | 37 | 40 | 39 |
| Normalized Punct. | 24.4 | 25.6 | 24.8 | 15.0 | 24.7 | 26.5 | 23.8 | 24.0 | 23.6 | 24.0 | 24.2 |
| Strength (gF/μm) | | | | | | | | | | | |
| Tensile Strength | 1300 | 1300 | 1400 | 700 | 1150 | 1500 | 1500 | 1500 | 1450 | 1550 | 1500 |
| MD//TD | 1450 | 1550 | 1400 | 800 | 1650 | 1450 | 1200 | 1250 | 1250 | 1200 | 1100 |
| (kgF/cm²) | | | | | | | | | | | |
| Tensile Elongation | 190 | 170 | 160 | 140 | 210 | 160 | 160 | 170 | 170 | 160 | 140 |
| MD//TD (%) | 210 | 170 | 190 | 140 | 130 | 210 | 260 | 280 | 280 | 270 | 220 |
| Heat Shrinkage | 5.0 | 5.0 | 7.0 | 4.5 | 2.5 | 4.5 | 6.0 | 5.5 | 6.5 | 6.0 | 7.5 |
| 105° C. MD//TD (%) | 7.0 | 6.5 | 8.0 | 5.0 | 2.5 | 6.0 | 4.0 | 4.5 | 4.5 | 3.5 | 3.5 |

Examples 1, 2, and 3 show that microporous membranes having desirable normalized air permeability and normalized pin puncture strength can be produced from polyolefin and liquid paraffin diluent. Table 1 shows that the membranes of the invention have both a normalized pin puncture strength greater than or equal to 20.0 gF per μm and a normalized air permeability less than or equal to 11.0 seconds/100.0 cm³/μm. This improvement is achieved without significantly degrading other important membrane properties such as porosity and heat shrinkage, over the membranes of the comparative examples. In particular, FIG. 1 shows that the membranes of the invention (shown on the figure as Ex. 1 through Ex. 3), particularly monolayer membranes having a thickness greater than about 23.0 μm, achieve a better balance of normalized pin puncture strength greater and normalized air permeability over the membranes of the comparative examples (shown as C.E. 1 through C.E. 8). The membranes of the comparative examples, as shown in FIG. 1, exhibit either desirable normalized air permeability or desirable normalized pin puncture strength, but not both.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all inventive features which reside herein, including all features which would be treated as equivalents thereof by those skilled in the art to which this disclosure pertains.

When numerical lower limits and numerical upper limits are listed herein, ranges from any lower limit to any upper limit are contemplated.

1. A microporous polymeric membrane having a normalized pin puncture strength ≧20.0 gF per μm, a normalized air permeability ≦11.0 seconds/100.0 cm³/μm, the surface of the membrane comprising micro-fibrils having an average diameter in the range of 20.0 to 1.0×10² nm, and an average distance between micro-fibrils >400.0 nm.

2. The microporous membrane of claim 1, wherein the membrane comprises a first polyethylene having an Mw in the range of 1.0×10⁶ to 5.0×10⁶ and an MWD in the range of about 2.0 to about 50.0 and a second polyethylene having an Mw in the range of 2.0×10⁵ to 9.0×10⁵ and an MWD in the range of about 2.0 to about 50.0.

3. The microporous membrane of claim 2, wherein the microporous membrane is a monolayer membrane having a thickness ≧23.0 μm.

4. The microporous membrane of claim 1, wherein the membrane's thickness is in the range of 23.0 μm to 30.0 μm, the normalized pin puncture strength is in the range of 22.0 gF per μm to 35.0 gF per μm, the normalized air permeability is in the range of 7.0 seconds/100.0 cm³/μm to 10.5 seconds/100.0 cm³/μm, the average diameter of the micro-fibrils is in the range of 40.0 nm to 70.0 nm and the average distance between micro-fibrils is in the range of 450.0 nm to 650.0 nm.

5. The microporous membrane of claim 1, wherein the membrane is produced from a mixture of polyolefin and liquid paraffin.

6. The microporous membrane of claim 1, wherein the membrane has a TD heat shrinkage at 105.0° C. in the range of 3.0% to 10.0% and an MD heat shrinkage in the range of 1.5% to 8.0%, a porosity in the range of about 45.0% to about 50.0%, an MD tensile strength ≧1.0×10³ Kg/cm³, a TD tensile strength ≧1.2×10³ Kg/cm³, an MD tensile elongation ≧50.0%, a TD tensile elongation≧50.0%, a shutdown temperature ≦140.0° C., a meltdown temperature ≧144.0° C., and a maximum MD heat shrinkage in the molten state ≦41.0%, and a maximum TD shrinkage in the molten state ≦46.0%.

7. The microporous membrane of claim 3, wherein:
(a) the first polyethylene is present in an amount in the range of from 25.0 wt. % to 35.0 wt. %, based on the total weight of the membrane, the first polyethylene having an Mw in the range of from about 1.1×10⁶ to about 3.0×10⁶ and an MWD in the range of from about 4.0 to about 15.0, and
(b) the second polyethylene is present in an amount in the range of from 65.0 wt. % to 75.0 wt. % based on the total weight of the membrane, the second polyethylene having an Mw in the range of from about 3.0×10⁵ to about 7.0×10⁵, an MWD in the range of from about 3.5 to about 5.0, and having a terminal unsaturation amount of less than 0.1 per 10,000 carbon atoms in the second polyethylene.

8. The microporous membrane of claim 7, wherein the membrane consists essentially of polyethylene.

9. The microporous membrane of claim 1, wherein the membrane's normalized air permeability A (seconds/100.0 cm³/μm) satisfies the relationship A≦(0.1P)+9, where P (gF per μm) is the normalized pin puncture strength.

10. A battery separator film comprising the microporous membrane of claim 1.

11. A method for manufacturing a microporous membrane, comprising:
(a) stretching in at least one planar direction an extrudate comprising (i) 60.0 wt. % to 80.0 wt. % of a liquid paraffin and (ii) 20.0 wt. % to 40.0 wt. % of a polyolefin mixture, the weight percents being based on the weight of the extrudate; the polyolefin mixture comprising 25.0 wt. % to 35.0 wt. % of a first polyethylene having an Mw≧1.0×10⁶ and 65.0 wt. % to 75.0 wt. % of a second polyethylene having an Mw<1.0×10⁶ and having a terminal unsaturation amount<0.2 per 10,000 carbon atoms in the second polyethylene, the weight percents being based on the weight of the polyolefin mixture:
(b) removing at least a portion of the diluent from stretched extrudate to produce a dried extrudate having a first dry length and a first dry width; and
(c) stretching the dried extrudate from the first dry width to a second dry width larger than the first width by a magnification factor in the range ≧1.3, the stretching being conducted while exposing the dried extrudate to a temperature in the range of 126.0° C. to 131.0° C., wherein the first dry length is constant during the stretching.

12. The method of claim 11, wherein the first polyethylene has an Mw in the range of 1.1×10⁶ to 5.0×10⁶ and an MWD in the range of about 4.0 to about 15.0, and the second polyethylene has an Mw in the range of 2.0×10⁵ to 9.0×10⁵ and an MWD of about 3.5 to about 5.0.

13. The method of claim 11, wherein the diluent one or more of aliphatic, alicyclic or aromatic hydrocarbons such as nonane, decane, decalin, p-xylene, undecane, dodecane; liquid paraffin; and mineral oil distillates.

14. The method of claim 11, wherein the thickness of the cooled extrudate is in the range of 1.2 to 1.8 mm.

15. The method of claim 11, wherein the extrudate of step (a) is cooled before stretching by exposing the extrudate to a temperature in the range of 15.0° C. to 25.0° C., and wherein the cooled extrudate is simultaneously stretched in MD and TD to an MD magnification factor equal to 5.0 and a TD magnification factor equal to 5.0 while exposing the cooled extrudate to a temperature in the range of 114.0° C. to 116.0° C., and wherein the stretched extrudate is exposed to a temperature in the range of 120.0° C. to 125.0° C. for a time in the range of 1.0 second to 100.0 seconds at a fixed length and width before the start of step (c).

16. The method of claim 11, wherein the diluent is removed from the stretched extrudate by contacting the stretched extrudate with a solvent.

17. The method of claim 11, wherein the magnification factor of step (c) is in the range of 1.30 to 1.40.

18. The method of claim 11, wherein the stretching of step (c) is conducted while exposing the dried extrudate to a temperature in the range of 126.6° C. to 127.9° C., at magnification factor in the range of 1.33 to 1.37.

19. The method of claim 11, wherein step (c) further comprises exposing the membrane to a heat setting temperature greater than or equal to the temperature to which the membrane was exposed during the stretching of step while maintaining the first dry length and the second dry width constant.

20. The method of claim 19, wherein the heat setting temperature is in the range of 126.6° C. to 127.9° C.

21. The membrane product of claim 11, step (c).

22. A battery comprising an anode, a cathode, an electrolyte, and at least one separator located between the anode and the cathode, the separator comprising a first polyethylene having an Mw in the range of 1.0×10⁶ to 5.0×10⁶ and an MWD in the range of about 2.0 to about 50.0 and a second polyethylene having an Mw in the range of 2.0×10⁵ to 9.0×10⁵ and an MWD in the range of about 2.0 to about 50.0.

23. The battery of claim 22, wherein the separator has a normalized pin puncture strength ≧20.0 gF per μm, a normalized air permeability ≦11.0 seconds/100.0 cm³/μm, the surface of the membrane comprising micro-fibrils having an average diameter in the range of 20.0 to 1.0×10² nm, and an average distance between micro-fibrils >400 nm.

24. The battery of claim 22, wherein the battery is a cylindrical battery.

25. The battery of claim 22, wherein the battery is a power source for a power tool, electric vehicle, or hybrid electric vehicle.
